(19) United States
(12) Patent Application Publication
(10) Pub. No.: US 2017/0143578 A1
(43) Pub. Date: May 25, 2017

(54) AID PAD OF EXTERNAL COMPRESSION TREATMENT COURSE

(71) Applicants: CHI-FANG YEH, TAOYUAN CITY (TW); LI-CHU LIN, TAOYUAN CITY (TW)

(72) Inventors: CAI-CIAN YE, KAOHSIUNG CITY (TW); SHUN-HUNG YE, KAOHSIUNG CITY (TW); ZIH-CING YE, KAOHSIUNG CITY (TW)

(21) Appl. No.: 15/136,010

(22) Filed: Apr. 22, 2016

(30) Foreign Application Priority Data
Nov. 20, 2015 (TW) 104218649

(51) Int. Cl. A61H 9/00

(52) U.S. Cl. CPC A61H 9/0078

(57) ABSTRACT

An aid pad of external compression treatment course includes a pad body and at least one adapter tube. The adapter tube is mounted in the pad body with two ends extending out of the pad body. The pipelines of the gas envelopes are collected in the pad body to beautify the appearance. The gas source, the controller and a certain number of gas envelopes are cooperatively integrated into the external compression equipment for executing the external compression treatment course. Therefore, the aid pad can eliminate the randomness of the conventional external compression equipment, reduce the cost and volume of the external compression equipment and have higher mobility in use. The aid pad can be quickly transferred to different sites without limitation of the mattress form. Therefore, the pain of a user (patient) can be eased in a more positive and reliable manner.

### BACKGROUND OF THE INVENTION

1. Field of the Invention

The present invention relates generally to a pad body, and more particularly to an aid pad of external compression treatment course. The aid pad can enhance the comfortableness of the external compression treatment course, eliminate the randomness of the conventional external compression equipment, lower the cost of the external compression equipment, reduce the volume of the external compression equipment and have higher mobility in use.

2. Description of the Related Art

It is widely accepted in medical field that external counter-pulsation/enhanced external counter-pulsation (ECP/EECP) is an unpopular, but effective and safe treatment option for angina pectoris and heart failure patients. In ECP/EECP, the external gas envelopes are used to compress a user to achieve a treatment effect. Such external compression treatment course can be further applied to a user to relax the muscle pressure or improve peripheral blood circulation problem or the like.

To speak more specifically, the external compression treatment equipment mainly includes multiple interconnected gas envelope sleeves for fitting on four limbs of a patient. For example, in some ECP systems, extra gas envelope sleeves are used to fit on a patient's femoral part and/or hip part. The gas envelope sleeves of the distal ends of the limbs are connected to a gas source and a set of controllers. Accordingly, sequentially, the gas envelope sleeves of the distal ends of the limbs are first pressured and then the gas envelope sleeves of the proximal ends of the limbs are pressurized. Also, according to the signals of the electrocardiogram (ECG) of the patient, the controllers serve to control the inflation and deflation start points of the respective gas envelope sleeves in synchrony with the signals of the electrocardiogram (ECG) of the patient.

When a user takes the external compression treatment course, it is generally suggested that the user takes the treatment in a lying state with the body naturally relaxed. In addition, a soft pad is generally placed under the knees of both legs. Under such circumstance, the legs of the user can rest on the soft pad in a more comfortable attitude. However, as shown in FIG. 1, the conventional external compression treatment equipment generally includes a gas source 11, a controller 12 and multiple gas envelopes 13, which are integrated with a clinic bed 14 on which a user can lie. A suspending support 141 is disposed on one side of the clinic bed 14. All the gas pressure pipelines 131 connected with the gas envelopes 13 are collected at the suspending support 141.

According to the above arrangement, the total manufacturing cost of the external compression equipment is increased. In addition, the external compression equipment has a huge volume to affect the appearance of the external compression equipment. Moreover, it is inconvenient to transfer and place the external compression equipment. Due to the poor mobility of the external compression equipment, it is often necessary for a user and medical workers to go to the site where the external compression equipment is positioned to perform the relevant treatment course. As a result, it is inconvenient to use the external compression equipment. Moreover, the frequent moves of the user (the patient) will lead to increase of pain of the user (the patient). Especially, the external compression equipment fails to have the function of supporting the patient's limbs. Therefore, it is necessary to additionally prepare a soft pad or a throw pillow for the user to take the treatment in a more comfortable manner.

### SUMMARY OF THE INVENTION

It is therefore a primary object of the present invention to provide an aid pad of external compression treatment course. The aid pad can enhance the comfortableness of the external compression treatment course, lower the cost of the external compression equipment, reduce the volume of the external compression equipment, beautify the appearance of the external compression equipment and have higher mobility in use.

To achieve the above and other objects, the aid pad of external compression treatment course of the present invention includes a pad body and at least one adapter tube. The pad body is an elastic structure body with a predetermined configuration. The adapter tube is mounted in the pad body with two ends oppositely extending out of the pad body by a predetermined length. At least one tube connector is disposed at each end of the adapter tube.

During the external compression treatment course for a user, the aid pad is padded under the knees of the user between the thighs and legs, whereby the user can take the external compression treatment in a relatively easy and comfortable manner. The pipelines of the gas envelopes are collected at the pad body to beautify the appearance. The gas source, the controller and a certain number of gas envelopes are cooperatively integrated into the external compression equipment for executing the external compression treatment course. Therefore, the aid pad can reduce the cost and volume of the external compression equipment and have higher mobility in use. The aid pad can be quickly transferred to different sites without limitation of the mattress form. Therefore, the pain of a user (patient) can be eased in a more positive and reliable manner.

In the above aid pad of external compression treatment course, multiple tube connectors are disposed at one end of the adapter tube.

In the above aid pad of external compression treatment course, the pad body has a semi-cylindrical configuration (as shown in FIG. 2).

In the above aid pad of external compression treatment course, the pad body has a cylindrical configuration (as shown in FIG. 4).

In the above aid pad of external compression treatment course, the pad body has a triangular prism configuration (as shown in FIG. 5).

In the above aid pad of external compression treatment course, the pad body is a solid body integrally made of foam material.

In the above aid pad of external compression treatment course, the pad body is a hollow body integrally made of foam material.

In the above aid pad of external compression treatment course, the pad body has an enclosure layer with a predetermined configuration and a filling is filled in the enclosure layer.

In the above aid pad of external compression treatment course, the filling is gas.

In the above aid pad of external compression treatment course, the filling is liquid.

In the above aid pad of external compression treatment course, the filling is natural cotton.

In the above aid pad of external compression treatment course, the filling is artificial cotton.

In the above aid pad of external compression treatment course, the filling is a foam rubber body.

In the above aid pad of external compression treatment course, the filling is multiple foam rubber granules.

In the above aid pad of external compression treatment course, the adapter tube is a rigid tube member.

In the above aid pad of external compression treatment course, the adapter tube is a flexible tube member.

In the above aid pad of external compression treatment course, the tube connectors of two ends of the adapter tube are strength-saving fast connectors.

In the above aid pad of external compression treatment course, at least one gas regulation module and an electromagnetic control switch are disposed in the pad body.

In the above aid pad of external compression treatment course, a height adjustment device is disposed on the pad body for adjusting the height of the pad body.

Substantially, the aid pad of external compression treatment course of the present invention is padded under the knees of the user between the thighs and legs, whereby the user can take the external compression treatment in a relatively easy and comfortable manner. The aid pad can beautify the appearance of the external compression equipment, lower the cost of the external compression equipment, reduce the volume of the external compression equipment and have higher mobility in use. The aid pad can be quickly transferred to different sites without limitation of the mattress form. Therefore, the pain of a user (patient) can be eased in a more positive and reliable manner.

The present invention can be best understood through the following description and accompanying drawings, wherein:

### BRIEF DESCRIPTION OF THE DRAWINGS

FIG. 1 is a perspective view of the conventional external compression treatment equipment;

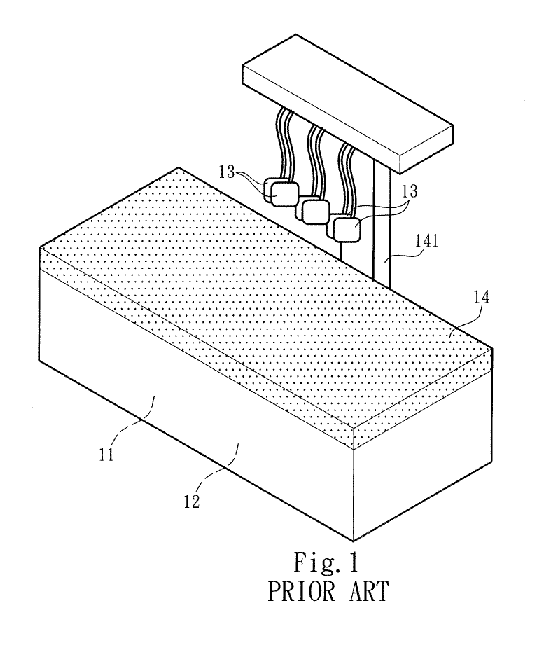

FIG. 2 is a plane view showing the use and arrangement of the aid pad of external compression treatment course of the present invention;

FIG. 3 is a perspective view of a first embodiment of the aid pad of external compression treatment course of the present invention;

FIG. 4 is a perspective view of a second embodiment of the aid pad of external compression treatment course of the present invention;

FIG. 5 is a perspective view of a third embodiment of the aid pad of external compression treatment course of the present invention;

FIG. 6 is a plane view of a fourth embodiment of the aid pad of external compression treatment course of the present invention, showing the use and arrangement of the aid pad;

FIG. 7 is a plane view of the third embodiment of the aid pad of external compression treatment course of the present invention, showing the use of the aid pad; and

FIG. 8 is a perspective view of a fifth embodiment of the aid pad of external compression treatment course of the present invention.

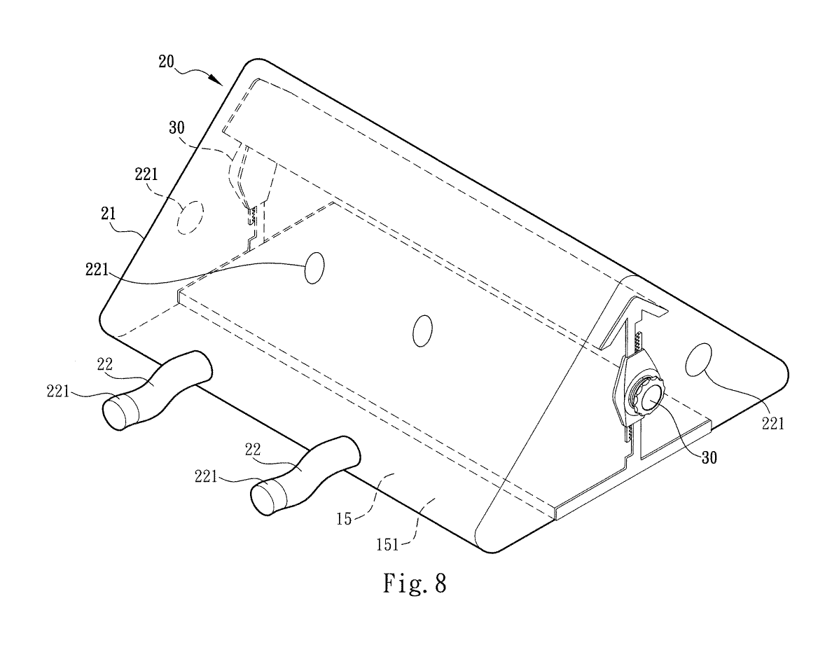

### DETAILED DESCRIPTION OF THE PREFERRED EMBODIMENTS

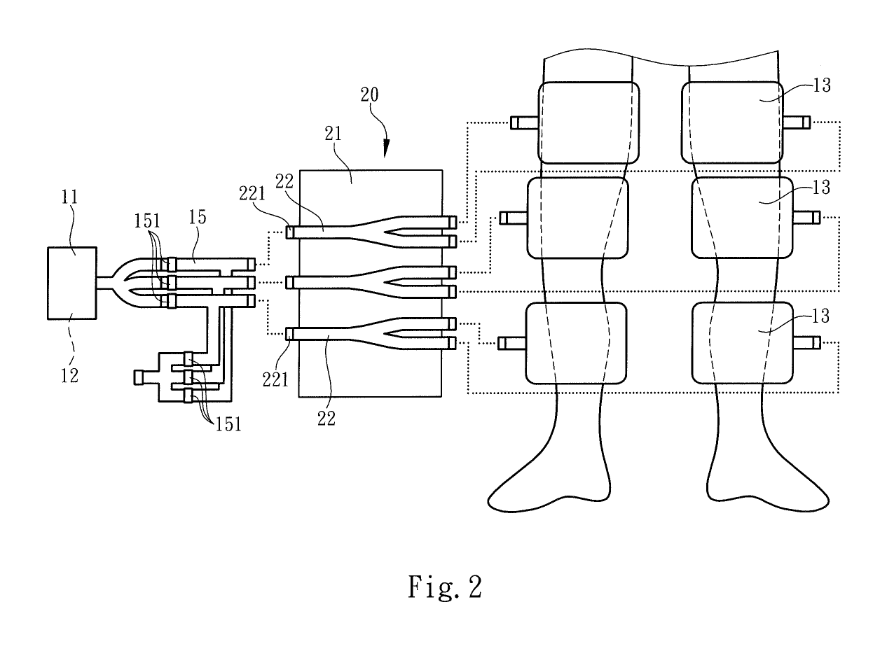

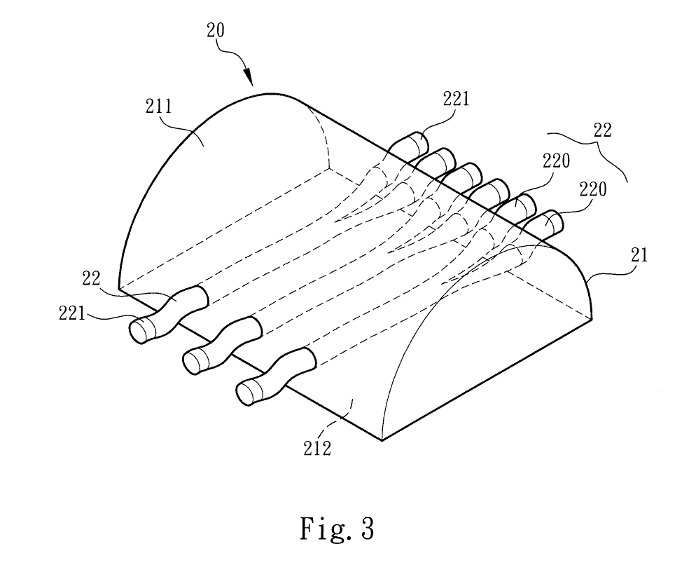

Please refer to FIGS. 2 and 3. The aid pad 20 of external compression treatment course of the present invention can enhance the comfortableness of the external compression treatment course, lower the cost of the external compression equipment, reduce the volume of the external compression equipment, beautify the appearance of the external compression equipment and have higher mobility in use. As shown in FIG. 3, the aid pad 20 of external compression treatment course of the present invention includes a pad body 21 and at least one adapter tube 22.

The pad body 21 is an elastic structure body with a predetermined configuration. In practice, the pad body 21 can be a solid body or a hollow body integrally made of foam material. The pad body 21 can have an enclosure layer 211 with a predetermined configuration. A filling 212 is filled in the enclosure layer 211. In such structural form, the enclosure layer 211 can be true leather, synthetic leather, a plastic bag body or a fabric. The filling 212 can be gas, liquid, natural cotton, artificial cotton, a foam rubber body or multiple foam rubber granules.

The adapter tube 22 is mounted in the pad body 21 with two ends oppositely extending out of the pad body 21 by predetermined length. At least one tube connector 221 is disposed at each of two ends of the adapter tube 22. In practice, the adapter tube 22 can be a rigid tube member (such as an aluminum tube, a stainless steel tube or a plastic tube). Alternatively, the adapter tube 22 can be a flexible tube member (such as a rubber tube or a plastic tube). Preferably, the tube connectors 221 of two ends of the adapter tube 22 are strength-saving fast connectors.

In principle, the aid pad 20 of external compression treatment course of the present invention is connectable to an external gas regulation module 15. During the external compression treatment course for a user, the aid pad 20 is padded under the knees of the user between the thighs and legs. The pad body 21 serves to support the weight of the limbs of the user, whereby the user can take the external compression treatment in a relatively easy and comfortable manner. The gas regulation module 15 has an electromagnetic control switch 151, which can control the gas pressure well.

Especially, the adapter tube 22 passes through the pad body 21 to connect the gas envelopes 13 and the gas source 11. Accordingly, the pipelines of the gas envelopes 13 are effectively collected at the pad body 21 to beautify the appearance. Moreover, the gas source 11, the controller 12 and a certain number of gas envelopes 13 can be cooperatively integrated into the external compression equipment for executing the external compression treatment course. Therefore, the cost of the external compression equipment is lowered, the volume of the external compression equipment is reduced and the mobility in use of the external compression equipment is enhanced. The external compression equipment can be quickly transferred to different sites without limitation of the mattress form. Therefore, the pain of a user (patient) can be eased in a more positive and reliable manner.

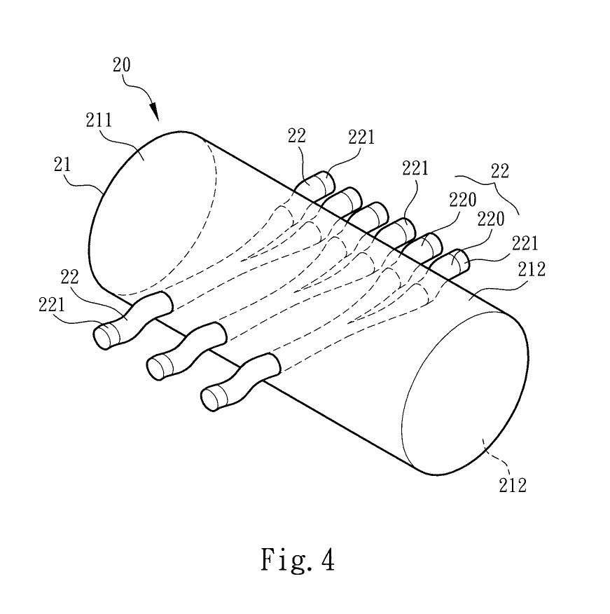

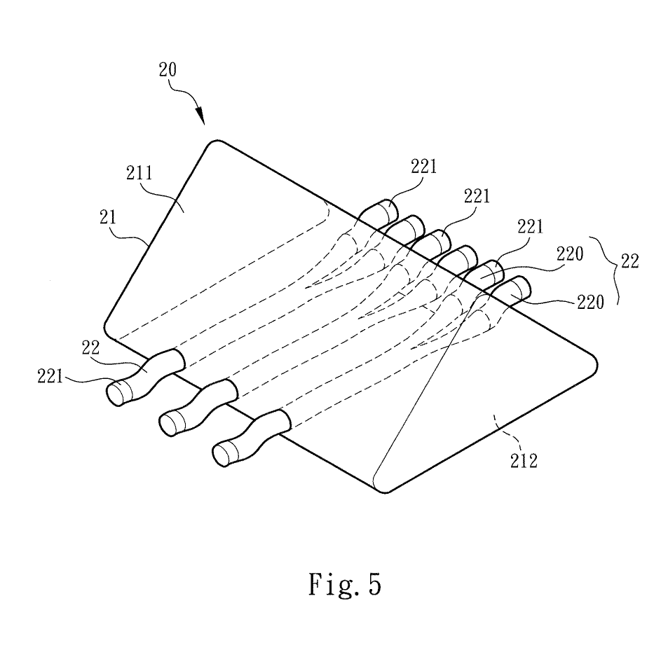

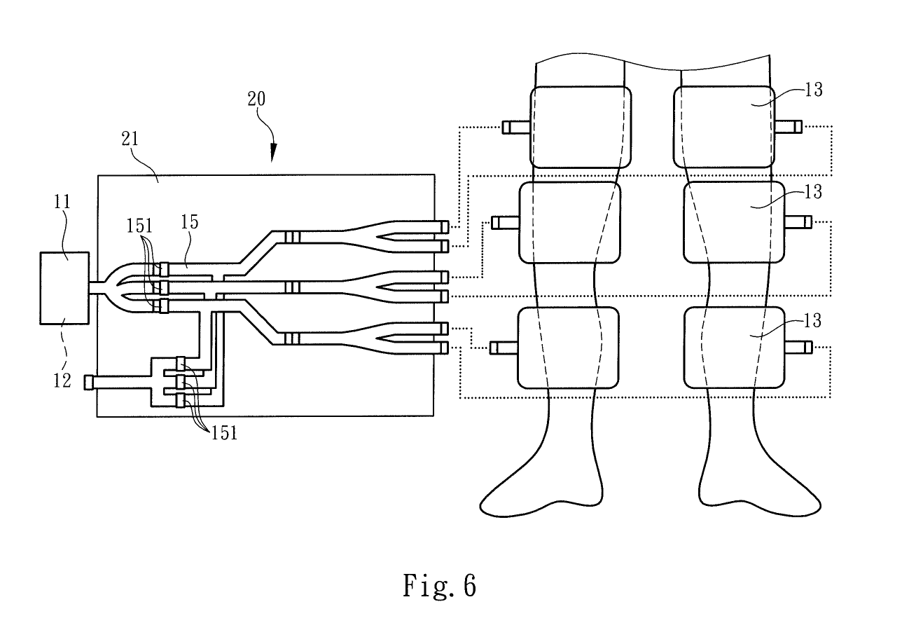

Furthermore, in practice, in the aid pad 20 of external compression treatment course of the present invention, one end of the adapter tube 22 can be forked into multiple branch tube ends 220. Therefore, the same adapter tube 22 can be connected to multiple gas envelopes 13, whereby the multiple gas envelopes 13 can be controlled to synchronously expand or contract. In addition, in the structural forms of the above embodiments, the pad body 21 can have a semi-cylindrical configuration as shown in FIG. 3. Alternatively, the pad body 21 can have a cylindrical configuration as shown in FIG. 4. Still alternatively, the pad body 21 can have a triangular prism configuration as shown in FIG. 5. FIG. 6 shows another embodiment of the aid pad 20 of external compression treatment course of the present invention. In this embodiment, the gas regulation module 15 and the electromagnetic control switch 151 are disposed on the pad body 21 to achieve a diversified assembly and application.

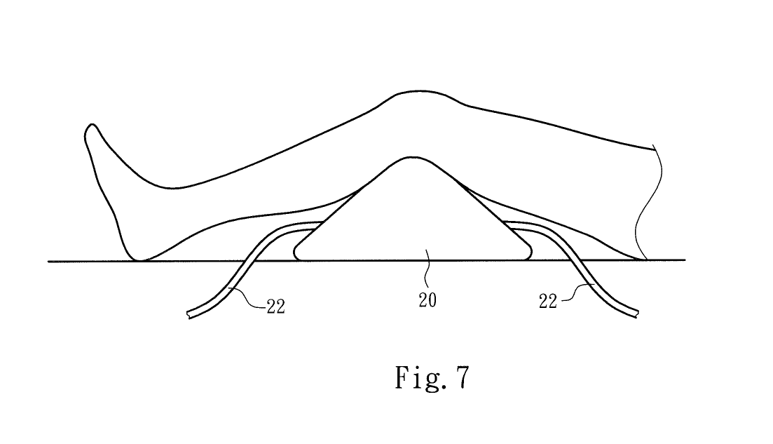

In comparison with the conventional technique, the aid pad 20 of external compression treatment course of the present invention can be padded under the knees of a user between the thighs and legs (as shown in FIG. 7). Moreover, a height adjustment device 30 can be disposed between an upper section and a lower section of the pad body 21. In this case, the aid pad 20 is applicable to different users with different leg bow heights. Accordingly, the user can take the external compression treatment in a relatively easy and comfortable manner. In addition, the appearance can be beautified. Also, the cost of the external compression equipment is lowered, the volume of the external compression equipment is reduced and the mobility in use of the external compression equipment is enhanced. The external compression equipment can be quickly transferred to different sites without limitation of the mattress form. Therefore, the pain of a user (patient) can be eased in a more positive and reliable manner.

The above embodiments are only used to illustrate the present invention, not intended to limit the scope thereof. Many modifications of the above embodiments can be made without departing from the spirit of the present invention.

What is claimed is:

1. An aid pad of external compression treatment course, comprising a pad body (21) and at least one adapter tube (22), wherein:
the pad body (21) is an elastic structure body with a predetermined configuration; and
the adapter tube (22) passes through the pad body (21) and two ends of the adapter tube (22) respectively extend out of the pad body (21).

2. The aid pad of external compression treatment course as claimed in claim 1, wherein one end of the adapter tube (22) is forked into multiple branch tube ends (220).

3. The aid pad of external compression treatment course as claimed in claim 1, wherein a tube connector (221) is disposed at each end of the adapter tube (22).

4. The aid pad of external compression treatment course as claimed in claim 2, wherein a tube connector (221) is disposed at each end of the adapter tube (22).

5. The aid pad of external compression treatment course as claimed in claim 1, wherein a height adjustment device is disposed between an upper section and a lower section of the pad body.

6. The aid pad of external compression treatment course as claimed in claim 2, wherein a height adjustment device is disposed between an upper section and a lower section of the pad body.

7. The aid pad of external compression treatment course as claimed in claim 3, wherein a height adjustment device is disposed between an upper section and a lower section of the pad body.

8. The aid pad of external compression treatment course as claimed in claim 4, wherein a height adjustment device is disposed between an upper section and a lower section of the pad body.

9. The aid pad of external compression treatment course as claimed in claim 1, wherein the pad body (21) has a cross-sectional shape selected from a group consisting of semi-circular shape, circular shape and triangular shape.

10. The aid pad of external compression treatment course as claimed in claim 2, wherein the pad body (21) has a cross-sectional shape selected from a group consisting of semi-circular shape, circular shape and triangular shape.

11. The aid pad of external compression treatment course as claimed in claim 3, wherein the pad body (21) has a cross-sectional shape selected from a group consisting of semi-circular shape, circular shape and triangular shape.

12. The aid pad of external compression treatment course as claimed in claim 4, wherein the pad body (21) has a cross-sectional shape selected from a group consisting of semi-circular shape, circular shape and triangular shape.

13. The aid pad of external compression treatment course as claimed in claim 5, wherein the pad body (21) has a cross-sectional shape selected from a group consisting of semi-circular shape, circular shape and triangular shape.

14. The aid pad of external compression treatment course as claimed in claim 6, wherein the pad body (21) has a cross-sectional shape selected from a group consisting of semi-circular shape, circular shape and triangular shape.

15. The aid pad of external compression treatment course as claimed in claim 1, wherein the pad body (21) is a solid body or a hollow body integrally made of foam material.

16. The aid pad of external compression treatment course as claimed in claim 2, wherein the pad body (21) is a solid body or a hollow body integrally made of foam material.

17. The aid pad of external compression treatment course as claimed in claim 5, wherein the pad body (21) is a solid body or a hollow body integrally made of foam material.

18. The aid pad of external compression treatment course as claimed in claim 6, wherein the pad body (21) is a solid body or a hollow body integrally made of foam material.

19. The aid pad of external compression treatment course as claimed in claim 1, wherein the pad body (21) has an enclosure layer (211) with a predetermined configuration, a filling (212) being filled in the enclosure layer (211).

20. The aid pad of external compression treatment course as claimed in claim 2, wherein the pad body (21) has an enclosure layer (211) with a predetermined configuration, a filling (212) being filled in the enclosure layer (211).

21. The aid pad of external compression treatment course as claimed in claim 5, wherein the pad body (21) has an enclosure layer (211) with a predetermined configuration, a filling (212) being filled in the enclosure layer (211).

22. The aid pad of external compression treatment course as claimed in claim 6, wherein the pad body (21) has an enclosure layer (211) with a predetermined configuration, a filling (212) being filled in the enclosure layer (211).

23. The aid pad of external compression treatment course as claimed in claim 19, wherein the filling (212) is selected from a group consisting of gas, liquid, natural cotton, artificial cotton, foam rubber body and foam rubber granules.

24. The aid pad of external compression treatment course as claimed in claim 20, wherein the filling (212) is selected from a group consisting of gas, liquid, natural cotton, artificial cotton, foam rubber body and foam rubber granules.

25. The aid pad of external compression treatment course as claimed in claim 21, wherein the filling (212) is selected from a group consisting of gas, liquid, natural cotton, artificial cotton, foam rubber body and foam rubber granules.

26. The aid pad of external compression treatment course as claimed in claim 22, wherein the filling (212) is selected from a group consisting of gas, liquid, natural cotton, artificial cotton, foam rubber body and foam rubber granules.

27. The aid pad of external compression treatment course as claimed in claim 1, wherein the adapter tube (22) is selected from a group consisting of a rigid tube member and a flexible tube member.

28. The aid pad of external compression treatment course as claimed in claim 2, wherein the adapter tube (22) is selected from a group consisting of a rigid tube member and a flexible tube member.

29. The aid pad of external compression treatment course as claimed in claim 5, wherein the adapter tube (22) is selected from a group consisting of a rigid tube member and a flexible tube member.

30. The aid pad of external compression treatment course as claimed in claim 6, wherein the adapter tube (22) is selected from a group consisting of a rigid tube member and a flexible tube member.

31. The aid pad of external compression treatment course as claimed in claim 1, wherein the tube connectors (221) of two ends of the adapter tube (22) are strength-saving fast connectors.

32. The aid pad of external compression treatment course as claimed in claim 2, wherein the tube connectors (221) of two ends of the adapter tube (22) are strength-saving fast connectors.

33. The aid pad of external compression treatment course as claimed in claim 5, wherein the tube connectors (221) of two ends of the adapter tube (22) are strength-saving fast connectors.

34. The aid pad of external compression treatment course as claimed in claim 6, wherein the tube connectors (221) of two ends of the adapter tube (22) are strength-saving fast connectors.

35. The aid pad of external compression treatment course as claimed in claim 1, wherein at least one gas regulation module (15) and an electromagnetic control switch (151) are disposed on the pad body (21).

36. The aid pad of external compression treatment course as claimed in claim 2, wherein at least one gas regulation module (15) and an electromagnetic control switch (151) are disposed on the pad body (21).

37. The aid pad of external compression treatment course as claimed in claim 5, wherein at least one gas regulation module (15) and an electromagnetic control switch (151) are disposed on the pad body (21).

38. The aid pad of external compression treatment course as claimed in claim 6, wherein at least one gas regulation module (15) and an electromagnetic control switch (151) are disposed on the pad body (21).
